(19) United States
(12) Patent Application Publication
(10) Pub. No.: US 2008/0148997 A1
(43) Pub. Date: Jun. 26, 2008

(54) Gypsum compositions with naphthalene sulfonate and modifiers

(76) Inventors: David R. Blackburn, Barrington, IL (US); Qingxia Liu, Vernon Hills, IL (US); Michael P. Shake, Johnsburg, IL (US)

Correspondence Address: GREER, BURNS & CRAIN, LTD., 300 SOUTH WACKER DRIVE, SUITE 2500, CHICAGO, IL, 60603, US

(21) Appl. No.: 11/644,210

(22) Filed: Dec. 22, 2006

(51) Int. Cl. C04B 11/00

(52) U.S. Cl. 106/708; 106/781

(57) ABSTRACT

An improved gypsum slurry that includes water, calcium sulfate hemihydrate, a naphthalene sulfonate dispersant and a modifier. The modifier is chemically configured to improve the efficacy of the naphthalene sulfonate dispersant. Preferred modifiers include cement, lime, slaked lime, soda ash, carbonates, silicates and phosphates.

### BACKGROUND

This invention relates to improved gypsum products. More specifically, it relates to an improved gypsum slurry that is flowable at low water concentrations, with less expense compared to using naphthalene sulfonate dispersants alone.

Gypsum products are commonly used as building materials for many reasons, such as wallboard. Wallboard sheets are easily joined together to make continuous walls of any size and shape. They are easily patched and have fire and sound proofing properties. Decorative finishes, such as wallpaper or paint readily adhere to plaster or wallboard surfaces to allow for a large variety of decorating options.

The strength of gypsum products made from full density slurries is inversely proportional to the amount of water used in their manufacture. Some of the water that is added to the gypsum slurry is used to hydrate the calcined gypsum, also known as calcium sulfate hemihydrate, to form an interlocking matrix of calcium sulfate dihydrate crystals. Excess water evaporates or is driven off in a kiln, leaving voids in the matrix once occupied by the water. Where large amounts of water were used to fluidize the gypsum slurry, more and larger voids remain in the product when it is completely dry. These voids decrease the product density and strength in the finished product. In the wallboard manufacturing process, a foam slurry is also added to the stucco slurry to achieve a desired wallboard weight.

Attempts have been made to reduce the amount of water used to make a fluid slurry using dispersants. Naphthalene Sulfonate dispersants are very effective at lowering the amount of water used in wallboard manufacturing process. There are disadvantages known to be associated with use of large doses of dispersants to achieve a high range of water reduction since these materials are relatively expensive. The high price of this component can overcome the narrow margins afforded these products in a highly competitive marketplace.

Lime has been used in plaster to improve its workability. It gives the plaster a good “feel”, imparting a smoothness and plasticity that makes it easy to trowel. Since it is alkaline, lime acts to make some retarders more efficient, increasing the open time of the plaster. Finally, the lime present in the plaster oxidizes over time to form calcium carbonate, giving the surface a hardness beyond that obtainable with plaster alone.

U.S. Pat. No. 5,718,759 teaches the addition of silicates to mixtures of beta-calcined gypsum and cement. In the examples, lignosulfates or naphthalene sulfonates are used as water-reducing agents. The addition of pozzolanic materials, including silicates, is credited with-reducing expansion due to the formation of ettringite. The composition is suggested for use in building materials, such as backer boards, floor underlayments, road patching materials, fire-stopping materials and fiberboard.

Luongo, in U.S. Pat. No. 6,391,958, teaches a novel wallboard composition combining gypsum with sodium silicates and a synthetic, cross-linking binder. Vinyl acetate polymers were the preferred cross-linking binder. The addition of sodium silicates reduces the amount of calcined gypsum that is needed to make a given number of panels. The weight of the building panel is reduced, making it easier for workers to move the panels before and during installations.

The prior art has failed to adequately address the problem of improving the efficacy of a given naphthalene sulfonate dispersant. Improving the efficacy of a dispersant would reduce the cost of the dispersant, maintaining the reasonable price of gypsum products.

Thus, there is a need in the art to reduce the dosage of dispersants used in a gypsum slurry while maintaining flowability of the slurry. Reduction in dispersant use would result in saving of costs spent on the dispersant.

### SUMMARY OF THE INVENTION

These and other problems are improved by this invention which includes the addition of an efficacy modifier to a gypsum slurry that increases the fluidity of slurries made with naphthalene sulfonate type of dispersants. When one or more of the modifiers is used, less dispersant is required to achieve a given fluidity resulting in lower dispersant cost.

More specifically, the invention relates to an improved gypsum slurry, that includes water, calcium sulfate hemihydrate, a naphthalene sulfonate dispersant and a modifier. The modifier is chemically configured to improve the efficacy of the naphthalene sulfonate dispersant. Preferred modifiers include cement, lime, slaked lime, soda ash, carbonates, silicates, phosphonates and phosphates.

In another embodiment of this invention, a gypsum panel is made from at least one facing sheet and a core made from the improved gypsum slurry. Yet another aspect of this invention is a method of making the gypsum slurry that includes selecting a modifier, mixing the modifier with a naphthalene sulfonate dispersant and adding the calcium sulfate hemihydrate.

Use of the modifiers herein described improves the efficacy of the dispersant in fluidizing the gypsum slurry. This improvement in efficacy is useful in different ways for various products. In some embodiments, less of the dispersant is used, reducing the cost so that a more competitively priced gypsum product can be made.

Instead of or in addition to reducing the dispersant dosage, the improved efficacy of the dispersant can also be used to reduce the amount of water used to make the gypsum slurry. In products where excess water is driven from the product in an oven or kiln, the manufacturing process can be made more fuel efficient, conserving fossil fuels and realizing the cost savings where there is less water to vaporize. Fuel savings can be based on either reduced kiln temperatures or shorter residence time in the kiln. Reducing the amount of water used also translates to a higher product density in some products, such as flooring. This results in greater product strength.

### DETAILED DESCRIPTION OF THE INVENTION

The gypsum slurry of this invention is made using water, calcined gypsum, a naphthalene sulfonate type dispersants and a modifier. Although the benefits of this invention are most clear when used in a slurry for a high strength gypsum product, it can be used with any slurry using a naphthalene sulfonate, even those that already utilize low doses of naphthalene sulfonate dispersant.

Any calcined gypsum or stucco is useful in this slurry, particularly alpha-calcined gypsum, beta-calcined gypsum, anhydrite, or combinations thereof. Preferably, the gypsum slurry includes at least 50% by weight of calcined gypsum on a dry solids basis. The slurry includes at least 75%, 80% or 90% by weight calcined gypsum in other preferred embodiments. Preferred stuccos include Moulding Plaster (beta-calcined gypsum) and HYDROCAL® brand stucco (alpha-calcined gypsum) or CAS-20-4 (anhydrite) by USG Corp., Chicago, Ill.

Reduction in the amount of water used to make the slurry is achieved by the addition of a naphthalene sulfonate dispersant. While not wishing to be bound by theory, the dispersant is believed to attach itself to the calcium sulfate, then the charged groups on the polymer repel each other, causing the gypsum particles to spread out and flow easily. When the slurry flows more easily, the amount of water can be reduced and still obtain a flowable fluid. In general, reduction in water results in increased product strength and lower drying costs. Preferred naphthalene sulfonates include DAXAD by GEO Specialty Chemicals, Ambler, Pa. The naphthalene sulfonate is used in amounts of up to about 0.5%, preferably from about 0.05% to about 0.5% active ingredient as a weight percent of gypsum weight, and more preferably from about 0.5% to about 0.25%.

The modifier can. be any substance, liquid or solid, which when combined with a naphthalene dispersant in a gypsum slurry, leads to an improvement the efficacy of the dispersant. Modifiers are not intended to be dispersants in themselves, but serve to allow the dispersant to be more effective. For example, at constant concentrations of dispersant, better fluidity is obtained when the modifier is used compared to the same slurry without the modifier. Although the exact chemistry involved in the use of modifiers is not fully understood, a likely mechanism is that the modifier such as soda ash interacts with the gypsum surface to help improve the dispersant effect. Any mechanism can be used by the modifier to improve the efficacy of the dispersant for the purposes of this invention.

Preferred modifiers include cement, lime, also known as quicklime or calcium oxide, slaked lime, also known as calcium hydroxide, hydrated lime, soda ash, also known as sodium carbonate, potassium carbonate, also known as potash, and other carbonates, silicates, hydroxides, phosphonates and phosphates. Preferred carbonates include sodium and potassium carbonate. Sodium silicate is a preferred silicate. A preferred phosphonate is the penta sodium salt of aminotri (methylene phosphonic acid), marketed commercially as DEQUEST® 2006 (Solutia, Inc., St. Louis, Mo.).

When lime or slaked lime is used as the modifier, it is used in concentrations of about 0.05% to about 1.0% based on the weight of the dry calcium sulfate hemihydrate. In the presence of water, lime is quickly converted to calcium hydroxide, or slaked lime, and the pH of the slurry becomes alkaline. The sharp rise in pH can cause a number of changes in the slurry chemistry. Certain additives, including sodium trimetaphosphate, break down as the pH increases. There can also be problems with hydration and, where the slurry is used to make wallboard or gypsum panels. There are problems with paper bond at high pH. For workers who come in contact with the slurry, strongly alkaline compositions can be irritating to the skin and contact should be avoided. Above pH of about 11.5, lime no longer causes an increase in fluidity. Therefore, it is preferred in some applications to hold the pH below about nine for optimum performance from this modifier. In other applications, such as flooring, a high pH has the benefit of minimizing mold and mildew. Alkali metal hydroxides, especially sodium and potassium hydroxides are preferred for use in flooring and plaster.

Other preferred modifiers include carbonates, phosphonates, phosphates and silicates. Preferably, the modifiers are used in amounts less than 0.25% based on the weight of the dry calcium sulfate hemihydrate. Above these concentrations, increases in the amount of modifier causes a decrease in the dispersant efficacy. These modifiers are preferably used in amounts of from about 0.05% to about 0.25% or from about 0.10% to about 0.25 weight % based on the gypsum weight.

Modifiers appear to be less effective if the calcium sulfate hemihydrate is wetted with the dispersant before the modifier is added to the mixture. It is, therefore, preferred that the dispersant and the modifier be combined prior to mixture with the stucco. If either the modifier or the dispersant is in a liquid form, the liquid is preferably added to the process water. The other of the modifier or the dispersant is then added to the water prior to addition of the calcium sulfate hemihydrate. Only a few seconds of mixing is needed to blend the modifier and the dispersant together. If both the modifier and the dispersant are in dry form, they can be mixed together and added simultaneously with the stucco. The preferred method of combining water, dispersant, modifier and stucco is further described in U.S. Ser. No. 11/152,323, entitled “Method of Making a Gypsum Slurry with Modifiers and Dispersants”, herein incorporated by reference.

It has also been noted that the naphthalene sulfonate dispersants and the modifiers react differently when used in gypsum from different sources. Laboratory tests indicate that gypsums from different geographical areas contain different salts and impurities. While not wishing to be bound by theory, the impurities present in gypsum are believed to contribute to the efficacy of both the dispersant and the modifier. Among the impurities present in stucco are salts that vary by geographical location. Many salts are known to be set accelerators or set retarders. These same salts may also change the efficacy of the naphthalene sulfonate dispersant by affecting the degree of fluidity that can be achieved. Naphthalene sulfonates are preferably utilized with the low-salt stucco.

As a result of the use of fluidity enhancing dispersants and modifiers to boost their performance, the amount of water used to fluidize the slurry can be reduced compared to slurries made without these additives. It must be understood that the stucco source, the calcining technique, the dispersant family and the modifier all work together to produce a slurry of a given fluidity.

Any amount of water may be used to make the slurry of this invention as long as the slurry has sufficient fluidity for the application being considered. The amount of water varies greatly, depending on the source of the stucco, how it is calcined, the additives and the product being made. For wallboard applications, a water to stucco ratio (“WSR”) of 0.20 to about 0.8 is used, preferably from about 0.4 to about 0.8, and more preferably from about 0.5 to about 0.7.

In a second aspect of this invention, the slurry is used to make gypsum panels or wallboard having increased strength. To form gypsum panels, the slurry is poured onto at least one sheet of facing material. Facing materials are well known to an artisan of gypsum panels. Multi-ply paper is the preferred facing material, however, single-ply paper, cardboard, plastic sheeting and other facing materials may be used.

Other additives are also added to the slurry as are typical for the particular application to which the gypsum slurry will be put. In some embodiments of the invention, additives are included in the gypsum slurry to modify one or more properties of the final product. These optional additives are used in the manner and amounts as are known in the art. Concentrations are reported in amounts per 1000 square feet of finished board panels (“MSF”). Set retarders (up to about 2 lb./MSF (9.8 g/m²)) or dry accelerators (up to about 35 lb./MSF (170 g/m²)) are added to modify the rate at which the hydration reactions take place. “CSA” is a set accelerator comprising 95% calcium sulfate dihydrate co-ground with 5% sugar and heated to 250° F. (121° C.) to caramelize the sugar. CSA is available from USG Corporation, Southard, Okla. plant, and is made according to U.S. Pat. No. 3,573,947, herein incorporated by reference. Potassium sulfate is another preferred accelerator. HRA is calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Both of these are preferred accelerators.

Another accelerator, known as wet gypsum accelerator or WGA, is also a preferred accelerator. A description of the use of and a method for making wet gypsum accelerator are disclosed in U.S. Pat. No. 6,409,825, herein incorporated by reference. This accelerator includes at least one additive selected from the group consisting of an organic phosphonate compound, a phosphate-containing compound or mixtures thereof. This particular accelerator exhibits substantial longevity and maintains its effectiveness over time such that the wet gypsum accelerator can be made, stored, and even transported over long distances prior to use. The wet gypsum accelerator is used in amounts ranging from about 5 to about 80 pounds per thousand square feet (24.3 to 390 g/m²) of board product.

Glass fibers are optionally added to the slurry in amounts of at least 11 lb./MSF (54 g/m²), depending upon the application of final products. Up to 15 lb./MSF (73.2 g/m²) of paper fibers are also added to the slurry. Wax emulsions or polysiloxanes are added to the gypsum slurry in amounts up to 90 lbs./MSF (0.4 kg/m²) to improve the water-resistance of the finished gypsum board panel.

In embodiments of the invention that employ a foaming agent to yield voids in the set gypsum-containing product to provide lighter weight, any of the conventional foaming agents known to be useful in preparing foamed set gypsum products can be employed. Many such foaming agents are well known and readily available commercially, e.g. from GEO Specialty Chemicals, Ambler, Pa. Foams and a preferred method for preparing foamed gypsum products are disclosed in U.S. Pat. No. 5,683,635, herein incorporated by reference. If foam is added to the product, the naphthalene sulfonate dispersant can be divided between the process water and the foam water prior to its addition to the calcium sulfate hemihydrate. A preferred method of incorporating one or more dispersants into the mixer water and the foam water is disclosed in U.S. Ser. No. 11/152,404 (Attorney Ref. No. 2033.73130), entitled, “Effective Use of Dispersants in Wallboard Containing Foam”, previously incorporated by reference.

A trimetaphosphate compound is added to the gypsum slurry in some embodiments to enhance the strength of the product and to reduce sag resistance of the set gypsum. Preferably the concentration of the trimetaphosphate compound is from about 0.03% to about 2.0% based on the weight of the calcined gypsum. Gypsum compositions including trimetaphosphate compounds are disclosed in U.S. Pat. No. 6,342,284 and 6,632,550, both herein incorporated by reference. Exemplary trimetaphosphate salts include sodium, potassium or lithium salts of trimetaphosphate, such as those available from Astaris, LLC., St. Louis, Mo. Care must be exercised when using trimetaphosphate with lime or other modifiers that raise the alkalinity of the slurry. Above a pH of about 9.5, the trimetaphosphate loses its ability to strengthen the product and the slurry becomes severely retardive.

Other potential additives to the wallboard are biocides to reduce growth of mold, mildew or fungi. Depending on the biocide selected and the intended use for the wallboard, the biocide can be added to the covering, the gypsum core or both. Examples of biocides include boric acid, pyrithione salts and copper salts. Biocides can be added to either the facing or the gypsum core. When used, biocides are used in the facings in amounts of about 500-1000 ppm.

In addition, the gypsum composition optionally can include a starch, such as a pregelatinized starch and/or an acid-modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). One of ordinary skill in the art will appreciate the methods of pregelatinizing raw starch, such as, for example, cooking raw starch in water at temperatures of at least about 185° F. (85° C.) or other methods. Suitable examples of pregelatinized starch include, but are not limited to, PCF 1000 starch, commercially available from Lauhoff Grain Company and AMERIKOR 818 and HQM PREGEL starches, both commercially available from Archer Daniels Midland Company. If included, the pregelatinized starch is present in any suitable amount. For example, if included, the pregelatinized starch can be added to the mixture used to form the set gypsum composition such that it is present in an amount of from about 0.5% to about 10% percent by weight of the set gypsum composition. Starches such as USG95 (United States Gypsum Company, Chicago, Ill.) are also optionally added for core strength.

Other known additives may be used as needed to modify specific properties of the product. Sugars, such as dextrose, are used to improve the paper bond at the ends of the boards. If stiffness is needed, boric acid is commonly added. Fire retardancy can be improved by the addition of vermiculite. These and other known additives are useful in the present slurry and wallboard formulations.

While individual gypsum panels can be made in a batch process, in a preferred process, gypsum board is made commercially in a continuous process formed into a long panel and cut into panels of desired lengths. The formed facing material is obtained and put into place to receive the gypsum slurry. Preferably, the facing material is of a width to form a continuous length of panel that requires no more than two cuts to make a panel with the desired finished dimensions. Any known facing material is useful in making the wallboard panels, including paper, glass mat and plastic sheeting. Facing material is continuously fed to the board line.

The slurry is formed by mixing the dry components and the wet components together in any order. Typically, liquid additives are added to the water, and the mixer is activated for a short time to blend them. Water is measured directly into the mixer. If modifiers are used, preferably the modifiers and dispersants are predissolved in the mixer water prior to introduction of the stucco. Dry components of the slurry, the calcined gypsum and any dry additives, are preferably blended together prior to entering the mixer. The dry components are added to the liquid in the mixer, and blended until the dry components are moistened.

The slurry is then mixed to achieve a homogeneous slurry. Usually, an aqueous foam is mixed into the slurry to control the density of the resultant core material. Such an aqueous foam is usually generated by high shear mixing of an appropriate foaming agent, water and air to prior to the introduction of the resultant foam into the slurry. The foam can be inserted into the slurry in the mixer, or preferably, into the slurry as it exits the mixer in a discharge conduit. See, for example, U.S. Pat. No. 5,683,635, herein incorporated by reference. In a gypsum board plant, frequently solids and liquids are continuously added to a mixer, while the resultant slurry is continuously discharged from the mixer, and has an average residence time in the mixer of less than 30 seconds.

The slurry is continuously dispensed through one or more outlets from the mixer through a discharge conduit and deposited onto a moving conveyor carrying the facing material and formed into a panel. Another paper cover sheet is optionally placed on top of the slurry, so that the slurry is sandwiched between two moving cover sheets which become the facings of the resultant gypsum panel. The thickness of the resultant board is controlled by a forming plate, and the edges of the board are formed by appropriate mechanical devices which continuously score, fold and glue the overlapping edges of the paper. Additional guides maintain thickness and width as the setting slurry travels on a moving belt. While the shape is maintained, the calcined gypsum is kept under conditions sufficient (i.e. temperature of less than about 120° F.) to react with a portion of the water to set and form an interlocking matrix of gypsum crystals. The board panels are then cut, trimmed and passed to dryers to dry the set but still somewhat wet boards.

Preferably, a two-stage drying process is employed. The panels are first subjected to a high temperature kiln to rapidly heat up the board and begin to drive off excess water. The temperature of the kiln and the residence time of the board vary with the thickness of the panel. By way of example, a ½-inch board (12.7 mm) is preferably dried at temperatures in excess of 300° F. (149° C.) for approximately 20 to 50 minutes. As water at the surface evaporates, it is drawn by capillary action from the interior of the panel to replace the surface water. The relatively rapid water movement assists migration of the starch and the pyrithione salt into the paper. A second-stage oven has temperatures less than 300° F. (149° C.) to limit calcination of the board.

### EXAMPLE 1

During a plant trial, soda ash was added to a gypsum composition containing naphthalene sulfonate (“NS”) dispersant. The plant was running 1867 pounds of stucco per 1000 ft² of board (12732.94 kg/1000 m²). HRA was added in the amount shown in Table I to maintain approximately above 50% hydration at the cutting knife. Table I also shows the types and amounts of dispersants added, as well as the slump tests. The amount of dispersant reported in Table I is based on the weight of the liquid dispersant, which contains approximately 40% active ingredient.

TABLE I

| Sample | R | | J | | K | |
|---|---|---|---|---|---|---|
| Stucco, | 1867 | (8155) | 1871 | (8173) | 1871 | (8173) |
| lb/1000 ft² | | | | | | |
| NS in Mixer, | 5.75 | (25.1) | 8 | (34.9) | 8 | (34.9) |
| lb/1000 ft² | | | | | | |
| (kg/1000 m²) | | | | | | |
| Soda Ash, | 1.84 | (8.0) | 0 | | 0 | |
| lb/1000 ft² | | | | | | |
| (kg/1000 m²) | | | | | | |
| HRA, | 20 | (87.4) | 11.5 | (50.2) | 11.5 | (50.2) |
| lb/1000 ft² | | | | | | |
| (kg/1000 m²) | | | | | | |
| Total Water, | 1339 | (5848) | 1338 | (5844) | 1338 | (5844) |
| lb/1000 ft² | | | | | | |
| (kg/1000 m²) | | | | | | |
| Slump | 7.25″ | (18.4 cm) | 7.375″ | (18.7 cm) | 7.0″ | (17.8 cm) |

In this commercial test, gypsum board was made with naphthalene sulfonate, with and without the addition of a modifier of soda ash. When 0.05% of soda ash based on the dry stucco weights was added to the mixer with the other components, the amount of naphthalene sulfonate needed to produce a given fluidity was decreased by almost 40%. This demonstrates the ability of soda ash solution to enhance the performance of a naphthalene sulfonate dispersant.

While a particular embodiment of the gypsum composition with naphthalene sulfonate dispersant and modifiers has been shown and described, it will be appreciated by those skilled in the art that changes and modifications may be made thereto without departing from the invention in its broader aspects and as set forth in the following claims.

What is claimed is:

1. A gypsum slurry comprising:
water;
calcined gypsum;
a naphthalene sulfonate dispersant; and
at least one modifier chemically configured to increase the efficacy of said naphthalene sulfonate dispersant.

2. The gypsum slurry of claim 1 wherein said modifier is selected from the group consisting of lime, soda ash, carbonates, silicates, phosphates, phosphonates and combinations thereof.

3. The gypsum slurry of claim 2 wherein said modifier is soda ash.

4. The gypsum slurry of claim 1 wherein said modifier is present in concentrations of about 0.1% to about 0.25% by weight based on the dry weight of said calcined gypsum.

5. The gypsum slurry of claim 1 wherein the pH of said slurry is less than about 9.

6. The gypsum slurry of claim 1 wherein said naphthalene sulfonate dispersant is present in amounts of about 0.05% to about 0.5% based on the dry weight of said calcined gypsum.

7. The gypsum slurry of claim 1 wherein said water is present in amounts of about 0.4 to about 0.8 based on the dry weight of said calcined gypsum.

8. A gypsum panel comprising
at least one facing material;
a gypsum core comprising the hydrated gypsum slurry of claim 1.

9. The gypsum panel of claim 8 wherein said modifier is selected from the group consisting of lime, soda ash, carbonates, silicates, phosphates, cement and combinations thereof.

10. The gypsum panel of claim 9 wherein said modifier is soda ash.

11. The gypsum panel of claim 8 wherein said modifier is present in concentrations of about 0.05% to about 0.25% by weight based on the dry weight of said calcined gypsum.

12. The gypsum panel of claim 8 wherein said naphthalene sulfonate dispersant is present in amounts of about 0.05% to about 0.5% based on the dry weight of said calcined gypsum.

13. The gypsum panel of claim 8 wherein said water is present in amounts of about 0.4 to about 0.6 based on the dry weight of said calcined gypsum.

14. A method of making a gypsum slurry comprising a naphthalene sulfonate dispersant comprising:
selecting a modifier chemically configured to increase the efficacy of the naphthalene sulfonate dispersant;
combining the modifier, a naphthalene sulfonate dispersant, water and calcined gypsum to form a gypsum slurry.

15. The method of claim 14 wherein the modifier is selected from the group consisting of lime, soda ash, carbonates, silicates, phosphates and cement.

16. The method of claim 14 wherein said combining step further comprises combining the naphthalene sulfonate dispersant and the modifier with the water prior to the addition of the calcined gypsum.
